(19) United States
(12) Patent Application Publication
(10) Pub. No.: US 2012/0179604 A1
(43) Pub. Date: Jul. 12, 2012

(54) METHOD AND SYSTEM FOR ALLOWING A USER TO CONTROL THE ORDER IN WHICH TRANSACTIONS ARE POSTED

(75) Inventors: Joe Blain, Milton, MA (US); Jeffrey Jacocks, Jamaica Plain, MA (US); Andrea Tittel, Boston, MA (US); Geoff Thomas, Needham, MA (US)

(73) Assignee: CITIZENS FINANCIAL GROUP, INC., Providence, RI (US)

(21) Appl. No.: 12/985,884

(22) Filed: Jan. 6, 2011

(51) Int. Cl. G06Q 40/00

(52) U.S. Cl. 705/40

(57) ABSTRACT

A method and system is provided that allows a banking customer to access their bank account via an online banking interface and manage the order in which transactions are posted against their account in a manner that allows them to minimize or eliminate the occurrence of an overdraft condition. Should the monetary balance within the account fall below zero, creating a potential overdraft condition, the customer is notified that such a zero or negative balance condition exists. The customer, using the user interface, can then access the account to arrange the various posted items in any order they want. Further, the customer is provided with the option of returning items to avoid the overdraft condition entirely.

### BACKGROUND OF THE INVENTION

The present invention relates generally to a method and system that allows a banking customer to manage the posting order of the transactions being settled against their account. More specifically, the present invention relates to a method and system that allows a banking customer to access their bank account via an online banking interface and manage the order in which transactions are posted against their account in a manner that allows them to minimize or eliminate the occurrence of an overdraft condition.

Consumers today are rapidly changing the manner in which they conduct monetary transactions. Most consumers are moving away from a transaction wherein they pay for goods and services with cash or checks. Instead these consumers are turning to the use of electronic transaction cards in the form of credit or debit cards. Consumers often find themselves using such electronic transaction cards for completing even the smallest everyday purchase, such as buying their morning coffee. Such electronic transaction cards then allow the customer to complete the transaction whereby money is transferred from a consumer account linked to the card to the provider of the goods and/or services. Often, however, this frequent use of electronic transaction cards for numerous purchases each day creates a flurry of activity that can be difficult for the consumer to track. When the balance in the account linked to the electronic transaction card gets low, an unsuspecting consumer can rack up several small charges that overdraft their account in turn accruing overdraft fees. In this regard there have been many recent news stories that include accounts of consumers, who in charging a coffee, accrued overdraft charges that ultimately resulted in that one coffee costing a consumer over $30 by the all of the charges were added up.

Further, there is a growing popularity surrounding the use of online banking to assist consumers in managing their finances and to receive and pay bills. These online interfaces allow consumers to electronically track various accounts and other financial endeavors. Additionally, the user can receive electronic billing in their account or if the user receives a paper bill, enter them into their computers, and manage payment of the bills electronically. The consumer then creates payment instructions in the online banking interface. For recurring bills, such as a mortgage, the consumer can also arrange so-called “direct debit” payment systems in which routine payment amounts are automatically debited from the consumer's bank account and credited to the biller's bank account on agreed transaction dates. The problem that arises here is that the accounts used in this fashion are typically the same accounts that are tied to the electronic transaction cards described above thereby making the flow of transaction in the account even more dynamic.

This dynamic flow of transactions through the user's account may often be difficult to manage or keep careful track of. While the automated computer systems maintain account balances with precision a consumer may lose track of a few purchases that they made along the way resulting in an overdraft condition in their bank account. Further, when enrolled for online banking and bill payment services, a customer may be confronted with a large bill that was unexpected until it arrived into the electronic payment queue. In such a position the customer must find a way in which to manage their cash flow in order to make the required payment by transferring or depositing additional funding into the bill pay account. Otherwise the bill may be paid late or not paid at all. One can easily see that over time, poorly managed cash flow can quickly become expensive and damaging for a consumer.

Accordingly, there is a need for a method and system that allows a banking customer to manage the posting order of the transactions being settled against their account. There is a further need for a method and system that allows a banking customer to access their bank account via an online banking interface and manage the order in which transactions are posted against their account in a manner that allows them to minimize or eliminate the occurrence of an overdraft condition.

### BRIEF SUMMARY OF THE INVENTION

In this regard, the present invention provides a method and system that allows a banking customer to manage the posting order of the transactions being settled against their account. More specifically, the present invention provides a method and system that allows a banking customer to access their bank account via an online banking interface and manage the order in which transactions are posted against their account in a manner that allows them to minimize or eliminate the occurrence of an overdraft condition.

In the context of the method and system of the present invention a customer maintains a banking account or establishes a new banking account such that the banking account contains a monetary balance therein. The banking account is an account that includes online account access thereto via a user interface that is connected to the account through an electronic communications network such as the Internet. As bills are posted in the account they are credited or debited against the monetary balance maintained therein. Should the monetary balance fall below zero creating a potential overdraft condition, the customer is notified that such a zero or negative balance condition exists. The customer, using the user interface, can then access the account to arrange the various posted items in any order they want. For example, the customer could move a large debit item to the bottom of the list such that only one single overdraft item exists, in turn allowing a plurality of smaller items to be paid first. It can be seen that in this manner the customer may have a single overdraft fee associated with the single large transaction rather than multiple overdraft fees relating to several transactions that were posted later. Further, the customer is provided with the option of returning items to avoid the overdraft condition entirely.

It should also be appreciated that in the context of the present invention, a fee may be established for this account feature. The fee may be a singular fee that is paid for use of the feature. In a preferred embodiment, the fee is established as a fixed monthly fee. Further, the fee may be structure in a manner that different customers may be charged different or even no fees depending on the overall banking services that they use.

Accordingly, it is an object of the present invention to provide a method and system that allows a banking customer to manage the posting order of the transactions being settled against their account. It is a further object of the present invention to provide a method and system that allows a banking customer to access their bank account via an online banking interface and manage the order in which transactions are posted against their account in a manner that allows them to minimize or eliminate the occurrence of an overdraft condition.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart depicting operation of the method and system of the present invention; and

FIG. 2 is a schematic of a computer implemented system to support operation of the method and system of the present invention.

### DETAILED DESCRIPTION OF THE INVENTION

Now turning to the method and system of the present invention in detail. As can be understood, the present invention most generally provides for a method and system that allows a banking customer to manage the posting order of the transactions being settled against their account. In the context of the method and system of the present invention a banking customer, when notified of a potential overdraft condition, accesses their bank account via an online banking interface and manages the order in which transactions are posted against their account in a manner that allows them to minimize or eliminate the occurrence of an overdraft condition.

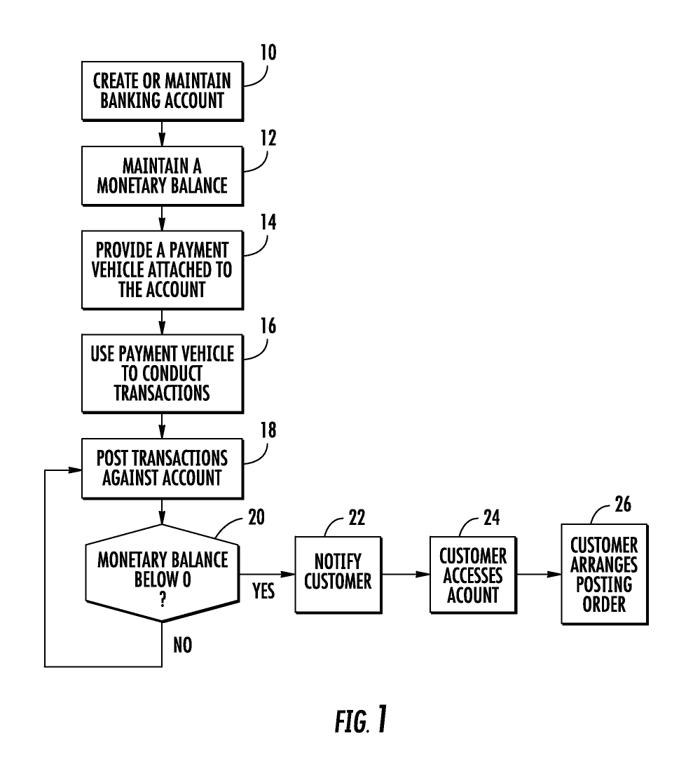

Turning now to FIG. 1, a flow chart is shown that depicts the specific the context of the method and system of the present invention. Specifically, in a preferred embodiment of the method and system of the present invention, a customer maintains a banking account or establishes a new banking account 10 such that the banking account contains a monetary balance 12 therein. The banking account is an account that includes online account access thereto via a user interface that is connected to the account through an electronic communications network such as the Internet. The customer employs a vehicle for payment of goods and services 14 such as the type typically attached to the account in the form of an electronic transaction card like a debit card or a charge card, a check or an online bill payment system. The payment vehicle is used in commerce to conduct transactions 16 in a manner well known in the art. As the charges associated with the bills are posted in the account 18, they are credited or debited against the monetary balance maintained therein as is known in the prior art.

In contrast to the prior art, the present invention provides a mechanism whereby, should the monetary balance fall below zero creating a potential overdraft condition 20, the customer is notified 22 that such a zero or negative balance condition exists. The mechanism for notifying the customer is preferably an electronic message in the form of a text message or an email. Alternatively, the customer notification may take the form of an automatic telephone call of telephone message. The message preferably alerts the customer to the fact that the account is at or near a zero balance condition thereby providing them an opportunity to take corrective action.

Once notified, the customer, using the user interface, can then access the account 24 to arrange the various posted items in any order they want 26. For example, the customer could move a large debit item to the bottom of the list such that only one single overdraft item exists, in turn allowing a plurality of smaller items to be paid first. It can be seen that in this manner the customer may have a single overdraft fee associated with the single large transaction rather than multiple overdraft fees relating to several transactions that were posted later. Further, the customer is provided with the option of returning items to avoid the overdraft condition entirely.

In operation therefore, by way of example, a customer upon accessing their account is presented with a listing of the items posting against their account in the order in which they were presented to the bank. The original balance may be $300 by way of example. Further, there can be seen four transactions one for $50 a second for $350 a third for $5 and a fourth for $12. In the prior art the $50 payment would be processed, the $350 transaction would result in an overdraft and then the third and fourth transactions would be refused resulting in three overdraft charges being assessed against the customer. In accordance with the present invention, when the $350 transaction is entered the customer is notified of the account balance. The customer accesses the account via the online interface and reorders the list of transaction such that the first, third and fourth transactions are posted before the second transaction for $350. This change alone results in a single overdraft charge rather than three. Further, the customer can return the $350 charge if desired to eliminate all of the overdrafts.

It should also be appreciated that in the context of the present invention, a fee may be established for this account feature. The fee may be a singular fee that is paid for use of the feature. In a preferred embodiment, the fee is a fixed monthly charge. Further, the fee may be structure in a manner that different customers may be charged different or even no fees depending on the overall banking services that they use. For example, the bank service provider may charge a monthly fee for a customer to have this feature activated on their account. It is also possible that the fee may be structured in a manner that different customers may be charged different or even no fees depending on the overall banking services that they use. For example, a customer of a basic checking account may pay a per payment fee to have this feature activated on their account while a consumer of a top tier account bundle that includes several accounts, bank service features and minimum maintained balances may receive this feature for nominal or no charge.

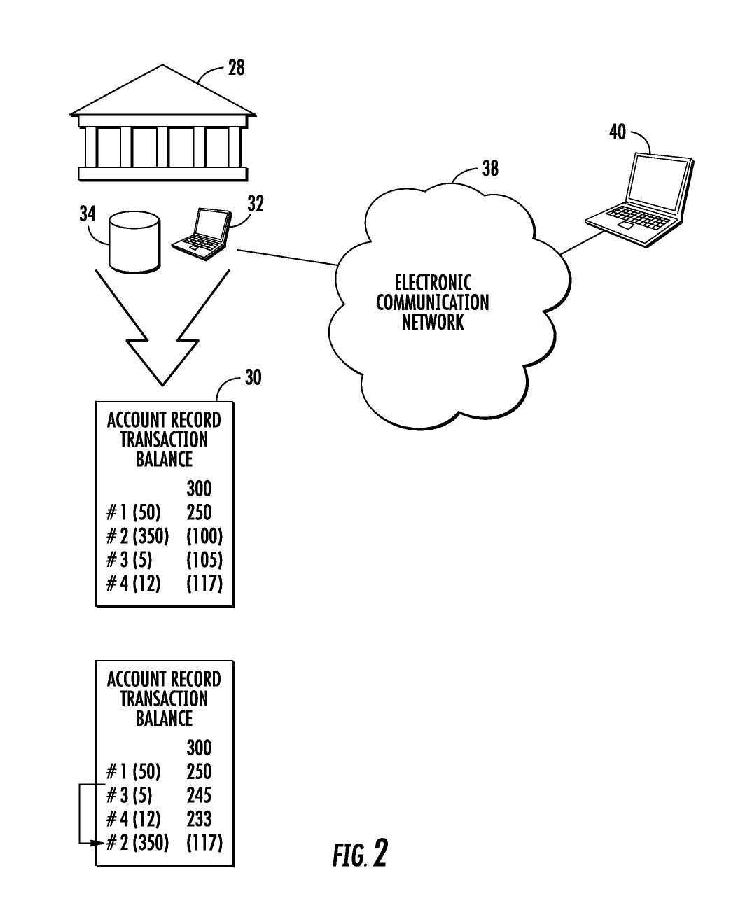

Turning to FIG. 2, the present invention is illustrated in the context of a computer implemented system wherein a customer maintains an existing bank account or establishes a new banking account at a bank service provider 28 that resides as an account record 30 on a computer server 32 or database system 34. The account record 30 contains a monetary balance therein that is recorded and tracked within the record 30 within the computer server 32 or database 34. In the preferred embodiment the computer server 32 or database system 34 is connected to an electronic communications network 38 that, in turn, allows electronic access to the account record 30. It is preferred that the banking account is established in a manner that allows electronic access thereto via the electronic communications network 38 for the purpose of online account access and management features.

As the customer conducts transactions they are posted against the account record and the value of each transaction is deducted from the account balance. Should the account balance drop to or below zero a notification is sent out to the customer advising of the overdraft condition. Once notified, the customer, using the user interface 40, accesses the account to view their account record 30 where they are presented with a list of the transactions posted thereto. The customer can then arrange the various posted transaction items in any order they want. Continuing the example discussed above, the customer via the user interface 40 can see four transactions, one for $50 a second for $350 a third for $5 and a fourth for $12. The customer using the method of the present invention reorders 31 the list of transactions such that the first, third and fourth transactions are posted before the second transaction for $350. While the end balance in the account is the same in either case, this change alone results in a single overdraft charge rather than three. Further, the customer can return the $350 charge if desired to eliminate all of the overdrafts.

It can therefore be seen that the present invention provides method and system that allows a banking customer to manage the posting order of the transactions being settled against their account wherein the banking customer accesses their bank account via an online banking interface and manages the order in which transactions are posted against their account in a manner that allows them to minimize or eliminate the occurrence of an overdraft condition. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. A method for managing transactions within a banking account, comprising:
providing at least one computer server comprising at least one processor executing instructions, the server performing the steps of:
enrolling a banking account maintained at a bank service provider into an online system that is accessible via a user interface, said banking account having a balance;
processing transactions conducted by a customer by posting the transactions against the banking account in the order received and deducting them from said balance;
notifying the customer when said balance approaches zero; and
processing instructions received through the online system to change the order in which the transactions are posted against the banking account.

2. The method of claim 1, further comprising:
charging a fee to allow the customer to change the order in which the transactions are posted.

3. The method of claim 2, wherein said fee is a flat fee that is added to the bill amount to be paid.

4. The method of claim 2, wherein said fee is waived if the customer utilizes a bundle of services offered by said bank service provider.

5. The method of claim 1, wherein said step of notifying said customer is accomplished by sending an electronic message to the customer.

6. The method of claim 5, wherein the electronic message is selected from the group consisting of: text message, email message and automated phone message.

7. The method of claim 1, wherein said banking account is an existing bank account.

8. The method of claim 1, wherein said banking account is a newly established bank account.

9. A computer implemented system for managing transactions within a banking account, comprising:
a banking account maintained as a computer record on a database at a bank service provider, said banking account including a monetary balance and a remotely accessible user interface, said user interface accessible via an electronic communications network, wherein transactions conducted by an account holder are posted directly to said account record in the order received and deducted from said monetary balance;
a monitoring system operating on said database that monitors the monetary balance of the banking account and notifies the account holder when said monetary balance approaches zero; and
a user interface embodied on a computing device for accessing said banking account, in communication with the electronic communications network, wherein said customer accesses the account through the electronic communications network and changes the order in which the transactions are posted against the account.

10. The system of claim 9, further comprising:
charging a fee to allow the customer to change the order in which the transactions are posted.

11. The system of claim 10, wherein said fee is a flat fee that is added to the bill amount to be paid.

12. The system of claim 10, wherein said fee is waived if the customer utilizes a bundle of services offered by said bank service provider.

13. The system of claim 9, wherein said account holder is notified by sending an electronic message.

14. The system claim 13, wherein the electronic message is selected from the group consisting of:
text message, email message and automated phone message.
